(19) United States
(12) Patent Application Publication
(10) Pub. No.: US 2006/0180672 A1
(43) Pub. Date: Aug. 17, 2006

(54) Method and system for multi-dimensional symbol coding system

(76) Inventor: Lonny L. Chu, South San Francisco, CA (US)

Correspondence Address: DERGOSITS & NOAH LLP, FOUR EMBARCADERO CENTER, SUITE 1450, SAN FRANCISCO, CA, 94111, US

(21) Appl. No.: 11/057,086

(22) Filed: Feb. 11, 2005

(51) Int. Cl. G06K 19/00; G06K 19/06

(52) U.S. Cl. 235/487; 235/494

(57) ABSTRACT

A set of discrete colored elements is arranged in a matrix to form a grid tag. The grid tag is like a bar code, useful to identify products or things. A starter color may orient a reader to read the colors in sequence, top-down and left-to-right. Associated with the grid tag is information located in a computer. The information may be referenced or the grid tag could be used as an “address” or a “pointer” to locate the information elsewhere on a computer or a network such as the Internet. A user may photograph the grid tag and transmit it to a server computer for parsing the colors and delivering information associated with the grid tag. Alternatively, the decoding may take place on a client device such as a wireless camera phone. In alternative embodiments, the grid tag elements may include logos, or other pictures that enable a user to identify the source or other pertinent information associated with the tag. Grid tags may be used for persons to identify themselves for a personal advertisement.

### COLOR DRAWINGS

The file of this patent contains at least one drawing executed in color. The Patent and Trademark Office will, upon request and payment of the necessary fee, provide copies of this patent with color drawings.

### TECHNICAL FIELD

This application is directed toward a multi-dimensional matrix symbol coding system for identifying a variety of objects and a method for providing information related to an object identified with the multi-dimensional matrix symbol coding system.

### BACKGROUND

Bar codes are widely in use to identify things such as grocery items, tools or inventory in a warehouse. Bar codes are also used in sorting and pricing things. A reading device configured to read and interpret the code can readily understand a bar code. Universal product codes, therefore, became popular because the codes can be understood by reading devices in a similar manner. The reading devices can read and interpret codes with great speed and accuracy, thus relieving a human reader from performing laborious tasks.

In addition to bar code systems, which are one-dimensional technologies, many two-dimensional technologies have been proposed. Some of these two-dimensional technologies have the additional advantage in that they could be read in any direction. But they did not become as popular as the simple bar code system. Accordingly, there is identified a need for an improvement in the art.

### SUMMARY

As used in this application, the term “symbol” is used to refer to the entire matrix and the word “element” is used to refer to the constituent parts of the matrix.

The present disclosure is directed toward a matrix-shaped symbol with discrete (i.e., with spaces in between) colored elements used to create a “bar code” or identification tag for a person, place or a thing. In an aspect, colored elements are arranged in a two-dimensional (2D) array to form a 2D colored grid. Color functions as a third dimension to the 2D array, making it in effect a three-dimensional (3D) array. Other dimensions may be added by using other information, such as sound, texture, elasticity, softness, (i.e., information that could be sensed by touching it), smell, taste, luminescence and the like, making the symbol a multi-dimensional symbol.

In an embodiment, three basic colors, red, green and blue are used to create the elements of the grid. A marker is used to indicate the start of the matrix so that the colors are read from that point. In one embodiment, the starter code is an element of a different color (i.e., other than those colors in the symbol that are used to identify things), e.g., black, to indicate a starting point. In another aspect, other colors are used. In alternative embodiments, the colors are read in a particular direction, either clock-wise or counter clock wise.

In order to achieve a familiar look and feel, the grid colors are limited to either a particular N×M matrix, where N is the number of rows and M is the number of columns (N and M could be the same or different positive numbers), and in particular embodiments, the grid tag could be a 4×4 matrix or a 5×5 matrix with colored elements arranged in the form of a matrix.

In an embodiment, the colored elements may represent the logos of the companies that market or manufacture the product on which the tag is placed. This makes the grid a multi-dimensional grid where the shape or other attribute of each of the elements in the two-dimensional grid of colored elements would be used to convey additional information about the item tagged by the grid. In a further aspect, advertising information or related product information may be associated with a grid tag, thereby enhancing the brand recognition for the product.

In a yet another aspect, the colors of the grid may be transmitted to another entity by way of their letter representations, that is, the letter “R” for red, the letter “G” for green, and the letter “B” for blue. Alternatively, numerical representations can be used. Using a telephone or other device capable of text messaging, for example, a user may push the buttons for the digit “7” to represent the letter “R,” the digit “4” to represent the letter “G” and the digit “2” to represent the letter “B” and transmit the grid tag to a location where the tag could be deciphered and relevant information sent to the user's device. In another aspect, a user may photograph, for example, using a camera embedded in a mobile telephone handset, and transmit the grid tag to another location. In a further aspect, the grid tag may be decoded at a server computer and provide a user with additional information related to or associated with the grid tag. In alternative embodiments, the decoding may take place on a client device, such as a cellular telephone, Portable Digital Assistant, tablet PC, personal computer, laptop computer and the like.

In alternative embodiments, the symbols described herein are customizable and brandable. They can be easily be modified during creation to reflect a company's branding image or an individual's personal aesthetic preferences. Moreover, they could be used as addresses or references to a database of information where a user may provide additional or related information regarding the branded product or thing or service for access.

A further feature of the present disclosed symbolic structures to identify products is that they can be scanned by any digital camera such as those found in a commercially available camera phones, and the colors may be perceived by a naked eye regardless of the quality (i.e., the number of mega pixels) of the camera itself.

### BRIEF DESCRIPTION OF THE DRAWINGS

These and other objects, features and advantages of this disclosure will be more readily understood in the following detailed description of the preferred embodiments and the appended claims with a reference to the drawings, where like numbers indicate like parts in the several views shown, and in which:

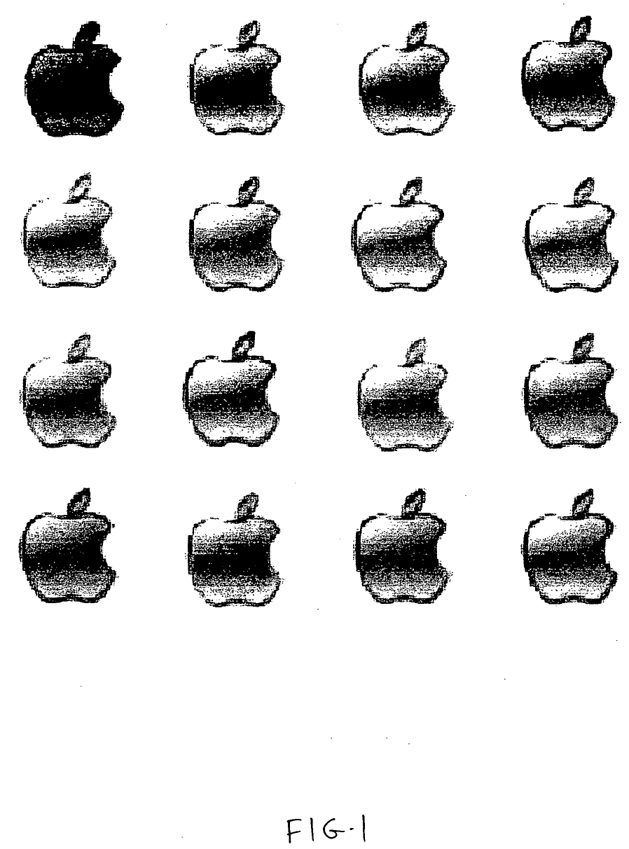

FIG. 1 shows an illustrative embodiment of a grid tag in accordance with the principles disclosed herein, where colored elements arranged in a matrix form a symbol;

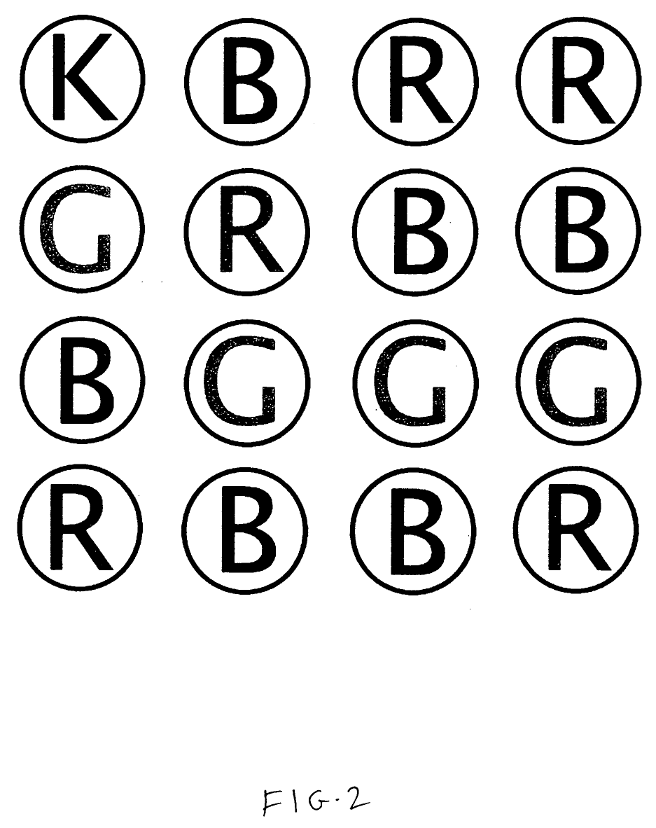

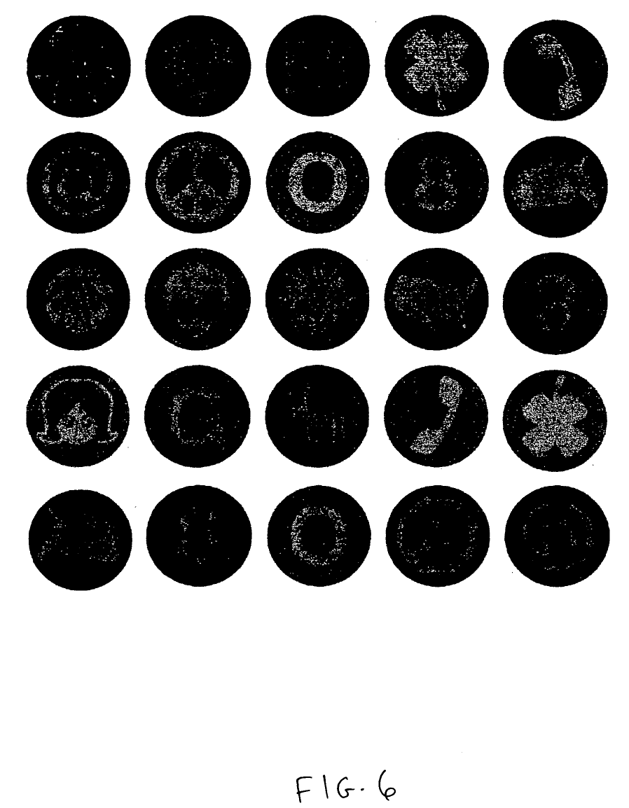

FIG. 2-6 show alternative illustrative embodiments of the symbol described herein; and

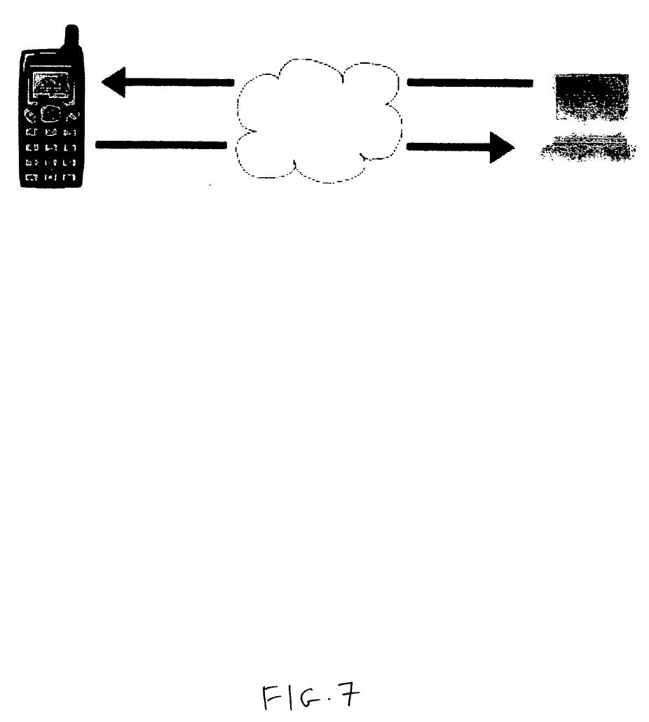

FIG. 7 shows a server computer connected to a client computer via a network.

### DETAILED DESCRIPTION

FIG. 1 illustrates a two-dimensional bar code symbol 100 in accordance with the instant disclosure. Note that in each discrete location or position of the matrix a colored element is present. In one aspect, the grid tag or symbol is made of a matrix of elements of different colors. Note that in the illustrative embodiment of FIG. 1, one may be able to read the symbols left to right and top to down or in any other fashion. Because the code may have to be transmitted one color at a time, a symbol may need to be “read”, that is, the colors in the symbol may need to be conveyed one color at a time. This requires that the manner in which the symbol is read be fixed or a protocol must be established so that a sender and a receiver would interpret the sequence of colors in the same manner so that they mean the same symbol.

In an exemplary embodiment, the symbol is always read left-to-right and top-to-bottom one row at a time. Applying this to the symbol at hand, the colors in FIG. 1 may be read as Black-Green-Green-Blue-Green-Blue-Red-Red-Green-Red-Green-Blue-Blue-Green-Blue-Red. Note that if the symbol were inverted, that is, if it were held upside down, a different sequence of colors may result if one reads the colors using the left-to-right and top-to-bottom one row at a time. Likewise, the symbol may be rotated clockwise or counterclockwise by 90°, an entirely different sequence may result. This is because the symbol is not symmetric. In order to avoid reading the symbol in different ways, one of the colors is designated as a starter color. In the illustration in FIG. 1, the starter color is denoted by a black element. The starter, when arranged to be at the top right hand corner of the symbol, will result in reading the elements in sequence in consistent manner. Omitting the starter, the sequence may be represented as (G G B G B R R G R G B B G B R), where the letter “R” denotes the color red, the letter “G” denotes the color green, and the letter “B” denotes the color blue. Note that colored elements are used to explain the features discovered here, but color may not be necessary in certain embodiments of the grid tag, such as in FIG. 2, where a monochrome symbol with elements represented by letters of the alphabet. To achieve consistency, in FIG. 2, a similar sequence is depicted as in FIG. 1, but persons of ordinary skill will be readily able to replace the letters B, G, R and K (for black) with other letters, marks, letters from alphabet of the several languages, and the like.

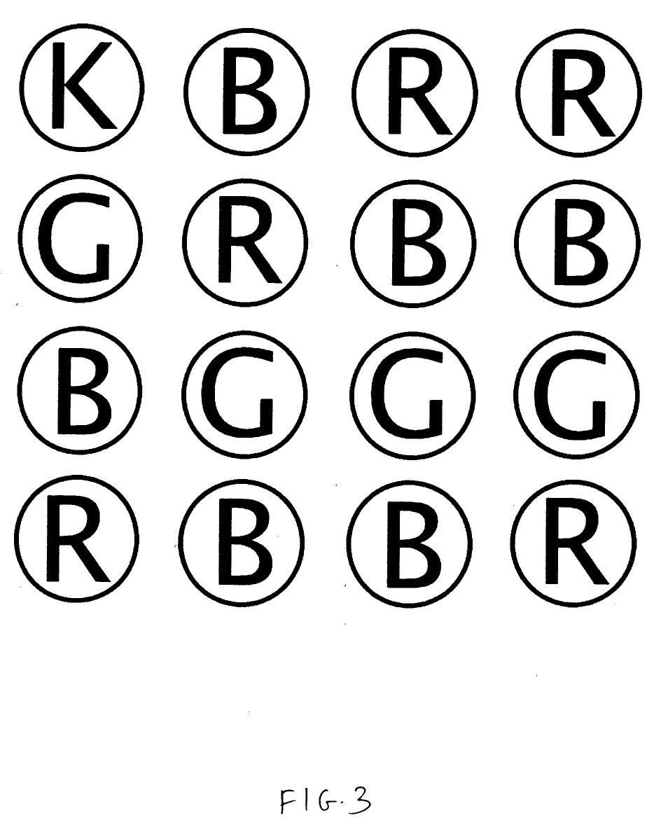

Referring to FIG. 3, a symbol 300 is shown but without the starter to designate the top right hand corner of the symbol grid. In this case, which is an alternative embodiment, instead of designating one of the elements as a starter, one may use some other indication extrinsic to the symbol, such as the designation 302, which signals to a reader that the corner so designated is the top right hand corner of the symbol, which results in a consistent interpretation of the elements in the symbol.

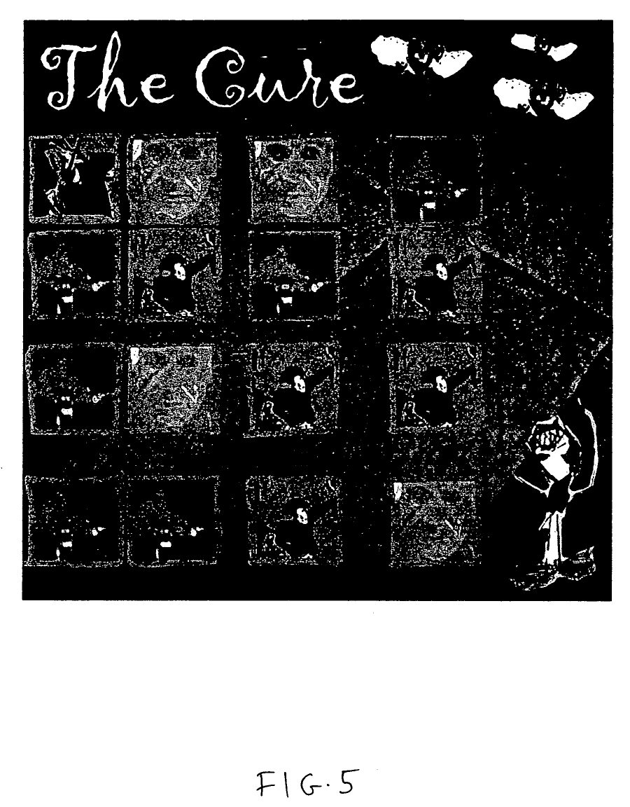

In an aspect of the invention symbols may be used to provide an identifier such as a bar code. In the example of FIGS. 1-3, each element of the matrix symbol is depicted as visible to the naked eye. In alternative embodiments, the element may be of any shape or any size. For example, in FIG. 1, the elements are made of a popular logo of the computer company Apple. FIG. 5 shows that the elements could be made up of characters from the rock band “The Cure.” An advantage of this type of depiction is that a company may provide a tag to its products and simultaneously display its logo in an attractive form for consumers to identify the product with the grid tag. As this type of product identification is akin to the Universal Product Code (bar code), without loss of generality, the terms “grid tag” and “bar code” are used interchangeably in this application to describe a matrix-type grid tag such as that depicted in FIG. 1.

Note that bar code symbol 100 has a rectangular shape with M rows and N columns, where M and N are positive numbers. In an embodiment, M is equal to N and in other embodiments M and N are unequal, resulting in a rectangular grid. In alternative embodiments, the symbol may have a circular, elliptical or other shape. The grid is made up of elements that have an attribute such as color, smell, texture, taste, luminescence, or other that could be used to index into a database for further information. Note that color is one of the attributes that can be associated with the elements of the symbol.

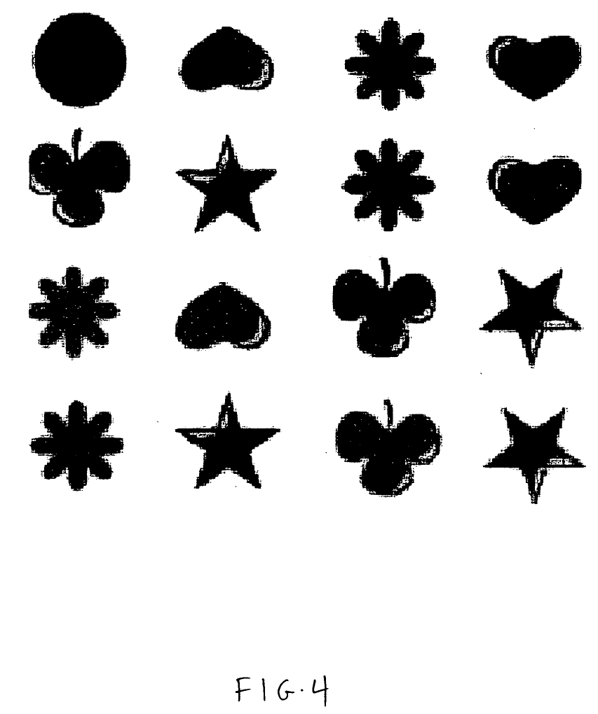

In alternative embodiments, the grid must be oriented such that a reading device may read the elements in the grid tag in a uniform manner. To facilitate this, a starter element may be designated. For example, in FIG. 4, the top left hand corner element of the grid tag is black. This enables a proper orientation of the grid so that a reading device may be used to read the grid, for example, from left to right and top to bottom. Alternative reading methods, for example, right to left or bottom to top or a zigzag reading method, are also possible.

Advantageously, the symbol is read and understood using a device specially configured to read the symbol. In an embodiment, a human eye reads the symbol. In alternative embodiments, a digital camera is used to take a picture of the symbol, or in the case of a tag that emits sound, a sound recording device may “read” the symbol. Likewise, in the case of a vibration, the symbol may be composed of a vibrating device, and the vibrations in the tag may be the result of a pressure or percussion device. These vibrations may be captured using, for example, an actuator or other similar device. In alternative embodiments, one or more elements of the tag could be a magnitude of force or pressure applied on the element. A computer receives the input from the symbol and interprets the symbol. Additional information regarding the symbol may be obtained by referencing a database that stores further information regarding the symbol. This is described in the following.

### Using a Grid Tag for Additional Information

As noted, a grid tag may be interpreted like a bar code. Information associated with a grid tag could be a product identifier, product name, its description, name of the manufacturer, a local vendor list, and the like. The grid tag information may be read using a reading device configured to interpret the grid tag. A grid tag or its pattern or design may be transmitted to a computer, which could interpret the grid tag, its pattern or design to obtain the additional information. In the case of a grid tag where an additional dimension is the color of the grid elements, a camera may advantageously take a picture of the symbol, which picture may be transmitted to a computer. Alternatively, a user may input the information in a search engine like Google, whereupon Google performs the required query with the database or uses the information cached in its computers to provide the result to the user. Thus, when a user inputs, for example, a string such as RGGRGBBRBBR, the search engine will return information that the tag belongs to a product, say, a 16-oz bottle of CocaCola®, sold in packs of six. The search engine may also return information where the product may be purchased.

Referring to FIG. 7, a client device 100 is coupled to a server computer 106 via a network 104. The client device 100 may be any computer or a hand held communication device such as a mobile phone, Personal Digital Assistant, laptop, desktop or the like. The client computer has a processor such as a general purpose microprocessor Pentium®, storage device such as a hard disk, a memory such as semiconductor memory, one or more input devices such as a keyboard, mouse, joystick or other pointing device, a voice recognizer, one or more output devices such as an LCD or a CRT screen, a speaker for audio output, and a communication interface device such as a modem for dialup connection or an Ethernet card for interfacing with a network such as the Internet.

The server computer 106 has a processor such as a general-purpose Pentium microprocessor, a storage device such as a hard disk, a memory such as semiconductor memory, an input device and an output device, a communication device such as a network card or a modem. The server computer 106 is also coupled to a database (not shown) such as an Oracle relational database management system or a data store such as a flat file, an indexed file or the like for storing information therein.

As stated, the client may be connected to the server via a network 104. The network could be public or private network, and in an embodiment is the public network such as the Internet.

When a user inputs the grid tag information into a device, it could be decoded either at the client device 100 or the server 106 and the results transmitted to the client device 100 via the network 104. In an embodiment, the client accesses the Internet 104 via a browser program and enters the grid tag in a search engine such as Google. The data sent to the server 106 by the client 102 may be in the form of a text file, a Uniform Resource Locator (URL), an address on the Internet, an E-mail message, an audio clip, a picture or a video, a short message (SMS), a text file, a markup language such as the SMS markup language, and the like. The response from the server computer 106 can be a text message, a video or an audio clip, a reference to a web site location, or the like.

While this invention has been explained with reference to the structure disclosed herein, it is not confined to the details set forth and this application is intended to cover any modifications and changes as may be made within the scope of the following claims.

What is claimed is:

1. A multi-dimensional symbol, comprising:
an arrangement of a plurality of elements each including a shape and one additional attribute, each of the plurality of elements being disconnected from other elements.

2. The multi-dimensional symbol of claim 1, wherein the additional attribute is color.

3. The multi-dimensional symbol of claim 1, wherein the additional attribute is texture.

4. The multi-dimensional symbol of claim 1, wherein the additional attribute is luminescence.

5. The multi-dimensional symbol of claim 1, wherein the additional attribute is smell.

6. The multi-dimensional symbol of claim 1, wherein the additional attribute is softness.

7. The multi-dimensional symbol of claim 1, wherein the additional attribute is taste.

8. The multi-dimensional symbol of claim 1, wherein the arrangement is in the form of a matrix.

9. The multi-dimensional symbol of claim 1, wherein the arrangement is in the form of a rectangular matrix.

10. The multi-dimensional symbol of claim 9, wherein the rectangular matrix is an N-by-M (N×M) matrix, where N and M are positive numbers.

11. The multi-dimensional symbol of claim 10, where N=M.

12. The multi-dimensional symbol of claim 10 where N≠M.

13. The multi-dimensional symbol of claim 10 where N>=1.

15. The multi-dimensional symbol of claim 10 where M>=1.

16. The multi-dimensional symbol of claim 1, wherein one of the plurality of elements is a starter element, whereby the elements in the symbol may be read in accordance with a predetermined sequence beginning with the starter element.

17. The multi-dimensional symbol of claim 16, wherein the elements are read in a clockwise direction from the starter color image.

18. The multi-dimensional symbol of claim 16, wherein the elements are read in a counter-clockwise direction from the starter color element.

19. The multi-dimensional symbol of claim 16, wherein the starter color is different from the colors used for identification of a person, place or a thing.

20. The multi-dimensional symbol of claim 1, wherein the elements comprise images made of at least three colors.

21. The multi-dimensional symbol of claim 20, wherein the three colors are red, green and blue.

22. A method of identifying a person, place or a thing by using a multi-dimensional symbol, the method comprising the steps of:
associating a person, place or thing with a unique symbol comprising an arrangement of a plurality of elements, each of said plurality of elements has a shape and an additional attribute.

23. The method of claim 22, wherein the additional attribute is color.

24. The method of claim 22, wherein the additional attribute is texture.

25. The method of claim 22, wherein the additional attribute is luminescence.

26. The method of claim 22, wherein the additional attribute is smell.

27. The method of claim 22, wherein the additional attribute is softness.

28. The method of claim 22, wherein the additional attribute is taste.

29. The method of claim 22, further comprising the step of:
storing information associated with a multi-dimensional symbol, wherein the multi-dimensional bar code symbol comprises a plurality of colored images arranged in the form of a rectangular matrix.

30. The method of claim 29, further comprising the step of:
receiving a request from a user, wherein the request comprises a multi-dimensional symbol;
associating the multi-dimensional symbol with stored information;
retrieving information associated with the multi-dimensional symbol; and
providing the retrieved information to the user.

31. The method of claim 30, wherein the step of providing the retrieved information to the user comprises the step of transmitting the retrieved information to a client computer.

32. The method of claim 30, wherein the step of providing the retrieved information to the user comprises the step of displaying the retrieved information to a user on a client computer.

33. The multi-dimensional symbol of claim 1, further including an orienting structure, wherein the orienting structure determines the beginning point of the symbol.

34. The multi-dimensional symbol of claim 19, wherein the orienting structure is external to the elements that form the symbol.
